(19) United States
(12) Patent Application Publication
(10) Pub. No.: US 2021/0303103 A1
(43) Pub. Date: Sep. 30, 2021

(54) TOUCH DEVICE AND ELECTRONIC APPARATUS

(71) Applicant: Shenzhen Royole Technologies Co., Ltd., Shenzhen (CN)

(72) Inventor: Lu Zeng, Shenzhen (CN)

(21) Appl. No.: 17/218,938

(22) Filed: Mar. 31, 2021

(30) Foreign Application Priority Data
Mar. 31, 2020 (CN) 202010248108.8

(51) Int. Cl. G06F 3/044; G06F 3/041

(52) U.S. Cl. CPC G06F 3/0444; G06F 2203/04107; G06F 2203/04104; G06F 3/04186

(57) ABSTRACT

The present application provides a touch device (1) and an electronic apparatus (2), wherein the touch device (1) comprises a touch panel (10) and a processor (20). the touch panel (10) is provided with a functional area (101) and a combination area (102), the touch panel (10) comprises an electrode layer (110), and the electrode layer (110) comprises a plurality of first touch units (30) and a plurality of second touch units (70). When the first touch unit (30) in the functional area (101) and the second touch unit (70) in the combination area (102) are simultaneously touched, the processor (20) detects a first signal and a second signal at a touch position and executes corresponding functions according to the first signal and the second signal to realize a combined touch operation.

### CROSS-REFERENCE TO RELATED APPLICATIONS

The present application claims priority to Chinese Patent Application No. 202010248108.8, filed on Mar. 31, 2020, in China National Intellectual Property Administration, the contents of which are herein incorporated by reference in its entirety.

### TECHNICAL FIELD

The present disclosure relates to the technical field of touch panels, and particularly relates to a touch device and an electronic apparatus.

### BACKGROUND

At present, since the touch device has the advantages of convenience in input, rich and diversified operability, strong intuition, and the like, the touch device has become a mainstream trend in the panel field. A user usually touches the touch device by a finger or other apparatuses so as to realize a corresponding touch control instruction. In some scenes, the user usually carries out multi-point touch control. However, a problem of “ghost points” sometimes occurs in multi-point touch control in a capacitive touch device, so that a processor cannot accurately judge the touch control position, which will finally cause the problem that an actual touch control instruction is not matched with the touch control instruction corresponding to the touch control position.

### SUMMARY

A first aspect of the present application provides a touch device, the touch device comprises a touch panel and a processor, and the touch panel is electrically connected with the processor; the touch panel is provided with a functional area and a combination area, the touch panel comprises an electrode layer, the electrode layer comprises a plurality of first touch units and a plurality of second touch units, and the first touch units and the second touch units are arranged at intervals in an insulating manner and are electrically connected with the processor respectively; when the first touch unit in the functional area and the second touch unit in the combination area are simultaneously touched, the processor detects a first signal and a second signal at a touch position, and executes corresponding functions according to the first signal and the second signal to realize a combined touch operation.

A second aspect of the present application provides an electronic apparatus comprising a shell, and a main board and a touch device arranged in the shell, wherein the main board is electrically connected with the touch device, and the touch device comprises the touch device as provided in the first aspect of the present application.

### BRIEF DESCRIPTION OF THE DRAWINGS

In order to more clearly illustrate the technical solutions in the examples of the present application, the drawings to be used in the examples of the present application will be described below.

FIG. 1 is a schematic diagram of an electrode layer in a touch device of the related art.

FIG. 2 is a schematic structural diagram of a touch device according to a first embodiment of the present application.

FIG. 3 is a schematic structural diagram of the electrode layer and the processor according to the first embodiment of the present application.

FIG. 4 is a schematic diagram of an electronic structure of the touch device according to the first embodiment of the present application.

FIG. 5 is a schematic diagram of the electrode layer during processing by the processor of the first embodiment of the present application.

FIG. 6 is a schematic diagram of a first touch unit and wiring in the touch device of the related art.

FIGS. 7 and 8 show reasons why the processor cannot make an accurate judgment when the first touch unit located in a frame area is touched in the related art.

FIG. 9 is a schematic diagram of a first touch unit in a touch device according to a second embodiment of the present application.

FIG. 10 is a schematic structural diagram of a touch device according to a third embodiment of the present application.

FIG. 11 is a schematic structural diagram of a touch device according to a fourth embodiment of the present application.

FIG. 12 is a schematic cross-sectional view of a touch device according to a fifth embodiment of the present application.

FIG. 13 is a schematic structural diagram of a second touch unit in a touch device according to a sixth embodiment of the present application.

FIG. 14 is a schematic structural diagram of a touch device according to a seventh embodiment of the present application.

FIG. 15 is a schematic structural diagram of a touch device according to an eighth embodiment of the present application.

FIG. 16 is a schematic structural diagram of a touch device according to a ninth embodiment of the present application.

FIG. 17 is a schematic structural diagram of an electronic apparatus according to an embodiment of the present application.

### DESCRIPTION OF THE REFERENCE NUMERALS

A touch device—1, an electronic apparatus—2, a shell—3, a main board—4, a touch panel—10, a sub-touch panel—100, a touch surface—11, a touch area—111, a non-touch area—112, a non-touch surface—12, a first substrate—13, a second substrate—14, a shielding layer—15, a connection layer—16, a functional area—101, a combination area—102, an electrode layer—110, a processor—20, a sub-processor—200, a first touch unit—30, a virtual first touch unit—31, a first driving electrode—32, a first sensing electrode—33, a frame area—34, a non-frame area—35, a wiring—50, a first wiring—51, a second wiring—52, a third wiring—53, a fourth wiring—54, a second touch unit—70, a second driving electrode—71, and a second sensing electrode—72.

### DETAILED DESCRIPTION

The following are preferred embodiments of the present application and it should be noted that some modifications and adaptations may be made by one of ordinary skill in the art without departing from the principles of the present application and are to be considered within the scope of this application.

Before introducing the technical solution of the present application, the technical problems in the following related art will be described in detail.

A touch device 1 of the present application is generally used for electronic apparatuses 2 such as mobile phones, tablet computers, touch keyboards and the like. Later in the application, a touch keyboard is used for illustration. Of course, a touch device 1 or other electronic apparatus 2 has the same technical problem. The appearance of the touch device 1 replaces a large number of physical key structures in the electronic apparatus 2, improving the screen occupation ratio of the electronic apparatus 2. A user only needs to make a touch control by the touch device 1, a touched area corresponds to a corresponding touch control instruction, and a processor 20 can directly execute the corresponding touch control instruction after detecting the area touched by the user. However, the user sometimes performs multi-point touch control, for example, a plurality of combined operations (such as ctrl+A, win−E and the like) often occur on the touch keyboard, so that double-point touch control needs to be performed simultaneously. However, a problem of “ghost points” may occur in some multi-point touch control operations in a capacitive touch device 1. The details of ghost points can be seen in FIG. 1. FIG. 1 is a schematic diagram of an electrode layer in a touch device of the related art. In the related art, the touch device 1 comprises a functional area 101 and a combination area 102, wherein the functional area 101 corresponds to touch control instructions such as 26 English letters, 10 numbers and the like, and the combination area 102 corresponds to touch control instructions such as ctrl, alt, win and the like. The electrode layer 110 comprises a plurality of first touch units 30, so that the first touch units 30 are simultaneously arranged corresponding to the functional area 101 and the combination area 102, and the processor 20 judges the actual touch area 111 by calculating the change amount of capacitance, voltage or current in the first touch units 30. When the touch control instruction of ctrl and the touch control instruction of the letter A are located in the same touch unit, and when the area corresponding to ctrl and A are simultaneously touched (as shown in FIG. 1), the processor 20 may mistakenly consider that the area touched by the touch device 1 is the area of letter Z, so that the combined touch control instruction of ctrl+A cannot be executed, and the processor 20 cannot accurately judge the touch position. Finally, it can cause the problem that the actual touch control instruction is not matched with the touch control instruction corresponding to the touch position.

In view of this, in order to solve the above-mentioned problem, the present application provides a touch device 1, wherein a first touch unit 30 and a second touch unit 70 are correspondingly arranged in a functional area 101 and a combination area 102 respectively, and the first touch unit 30 and the second touch unit 70 are electrically connected with a processor 20 respectively, so that the processor 20 can independently process signals transmitted by each area, thereby avoiding the problem of “ghost points”.

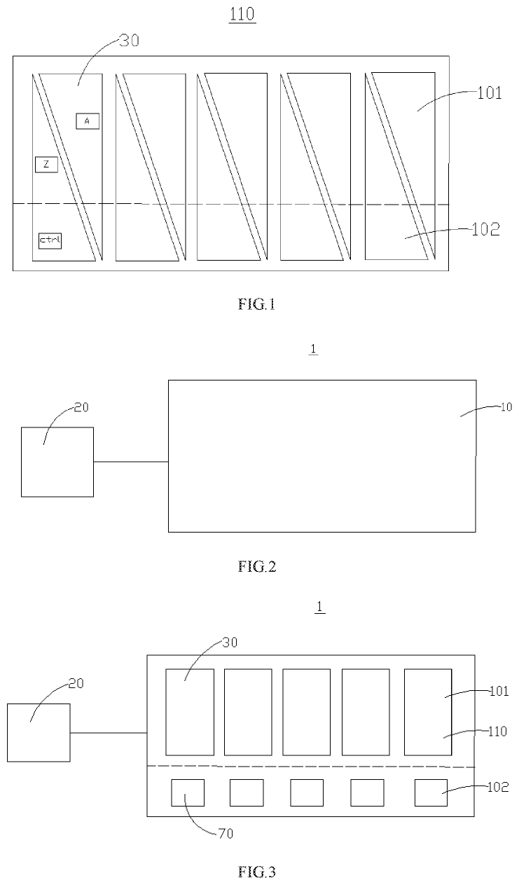

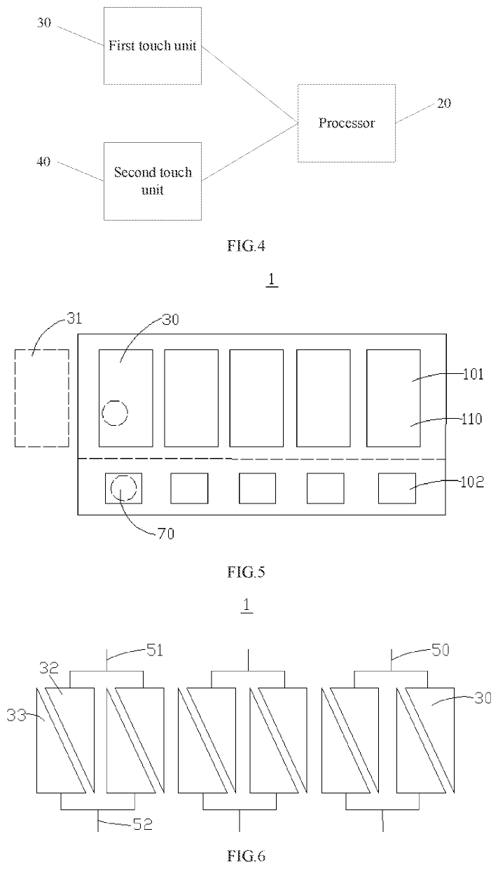

As seen in FIGS. 2, 3 and 4, FIG. 2 is a schematic structural diagram of a touch device 1 according to a first embodiment of the present application. FIG. 3 is a schematic structural diagram of the electrode layer and the processor according to the first embodiment of the present application. FIG. 4 is a schematic diagram of an electronic structure of the touch device according to the first embodiment of the present application. The embodiment provides a touch device 1, which can be used for an electronic apparatus with an ultra-thin structure (such as a flexible touch keyboard and the like). The touch device 1 comprises a touch panel 10 and a processor 20, wherein the touch panel 10 is electrically connected with the processor 20. The touch panel 10 is provided with a functional area 101 and a combination area 102, the touch panel 10 comprises an electrode layer 110, the electrode layer 110 comprises a plurality of first touch units 30 and a plurality of second touch units 70, and the first touch units 30 and the second touch units 70 are arranged at intervals and are electrically connected with the processor 20 respectively; and the first touch units 30 are arranged corresponding to the functional area 101, and the second touch unit 70 is arranged corresponding to the combination area 102. When the first touch unit 30 in the functional area 101 and the second touch unit 70 in the combination area 102 are touched simultaneously, the first touch unit 30 sends a first signal to the processor 20, the second touch unit 70 sends a second signal to the processor 20, and the processor 20 detects the first signal and the second signal at a touch position, and executes corresponding functions according to the first signal and the second signal to realize a combined touch operation.

The touch panel 10 of the present application has a functional area 101 and a combination area 102, wherein a instruction area for single-point touch control, such as 26 English letters, 10 numbers and the like, is generally provided in the functional area 101. When the area is touched, the processor 20 executes a touch control instruction corresponding to the touched position. An instruction area for a combined operation, such as ctrl, alt, win, etc., is generally provided in the combination area 102. When the area is touched, the processor 20 executes a touch control instruction corresponding to the touched position.

In addition, the touch panel 10 comprises an electrode layer 110, the electrode layer 110 comprises a plurality of first touch units 30 and a plurality of second touch units 70, and the first touch units 30 and the second touch units 70 are arranged at intervals and are electrically connected with the processor 20 respectively; and the first touch units 30 are arranged corresponding to the functional area 101, and the second touch units 70 are arranged corresponding to the combination area 102. Thus, when the first touch unit 30 in the functional area 101 and the second touch unit 70 in the combination area 102 are touched simultaneously, the processor 20 can respectively process the first touch unit 30 in the functional area 101 and the second touch unit 70 in the combination area 102; it can also be understood that the first touch unit 30 sends a first signal to the processor 20, the second touch unit 70 sends a second signal to the processor 20, the processor 20 can acquire a position where the first touch unit 30 is touched according to the first signal, and then obtain a corresponding touch control instruction (e.g., letter A) according to the position where the first touch unit 30 is touched, and the processor 20 can also acquire a position where the second touch unit 70 is touched according to the second signal, and obtain a corresponding touch control instruction (e.g., ctrl) according to the position wherein the second touch unit 70 is touched. Finally, the processor 20 obtains a combined touch control instruction (e.g., ctrl+A) according to the two touch control instructions so as to realize a combined touch operation. Here, the first signal may be a capacitance signal, a voltage signal or a current signal. The second signal may be a capacitance signal, a voltage signal or a current signal. Optionally, the first signal and the second signal are current signals. Therefore, according to the touch device 1 provided by the invention, the touch units are respectively arranged in different areas, so that the processor 20 can independently process signals transmitted by each area, thereby avoiding the problem that touch control judgment is inaccurate due to the condition of ghost points during multi-point touch control or combined touch control in the related art . Secondly, functions such as single-point clicking, single-point sliding, double-point relative sliding and the like can be realized by the touch control.

Alternatively, as can be seen from FIG. 5, FIG. 5 is a schematic diagram of the electrode layer during processing by the processor of the first embodiment of the present application. In this embodiment, when the first touch unit 30 in the functional area 101 and the second touch unit 70 in the combination area 102 are simultaneously touched, the processor 20 acquires the first signal according to the touched first touch unit 30 and obtains a first coordinate of the touched first touch unit 30 in the functional area 101 according to the first signal. The processor 20 also establishes a first virtual touch unit 31 located at the periphery of the functional area 101 according to the touched second touch unit 70 and acquires the second signal to obtain a first virtual coordinate of the first virtual touch unit 31 in the functional area 101 according to the second signal and obtain a second coordinate of the touched second touch unit 70 in the combination area 102 according to the first virtual coordinate; and then the processor executes corresponding functions according to the first coordinate and the second coordinate to realize the combined touch operation.

In the related art, the processor 20 cannot simultaneously process signals transmitted by two touch units, and can only process signals transmitted by one touch unit, that is, the processor 20 cannot simultaneously process a first signal transmitted by the first touch unit 30 and a second signal transmitted by the second touch unit 70. In an embodiment of the present application, the processor 20 can simultaneously process the signals transmitted by the two touch units by changing the algorithm of the processor 20, that is, simultaneously process the first signal transmitted by the first touch unit 30 and the second signal transmitted by the second touch unit 70. In the present embodiment, a virtual first touch unit 31 is established at the periphery of the first touch unit 30, and the second touch unit 70 is associated with the virtual first touch unit 31. For example, when the second touch unit 70 is touched, it is equivalent to the virtual first touch unit 31 also being touched. Therefore, the second touch unit 70 can be regarded as a part of the first touch unit 30, so that the processor 20 can simultaneously process the first signal transmitted by the first touch unit 30 and the second signal transmitted by the second touch unit 70.

In particular, the present application provides a processing method by a processor 20. As shown in FIG. 5, in the case that the first touch unit 30 in the functional area 101 and the second touch unit 70 in the combination area 102 are simultaneously touched, with regard to the first touch unit 30, when the first touch unit 30 is touched, a first signal (such as a circle in the first touch unit 30 in the figure) can be generated, and the first signal can comprise a capacitance signal, a voltage signal or a current signal, which is illustrated by the current signal in the present application. When the first touch unit 30 is touched, the current at the touch position changes, the processor 20 can judge the first coordinate of the touched first touch unit 30 in the functional area 101 according to the change of the current, and the processor 20 executes a touch control instruction (e.g., letter A) corresponding to the first coordinate.

With regard to the second touch unit 70, since the processor 20 cannot process the signals transmitted by the two touch units at the same time, when the second touch unit 70 is touched, a second signal (such as a circle in the second touch unit 70 in the figure) can be generated, and the second signal can comprise a capacitance signal, a voltage signal or a current signal, which is illustrated by the current signal in the present application. When the second touch unit 70 is touched, the current changes, i.e., the second signal is generated, and the processor 20 can establish a virtual first touch unit 31 at the periphery of the functional area 101 according to the generation of the second signal, and the second signal can be transmitted to the virtual first touch unit 31 before being transmitted to the processor 20. Thus, the processor 20 considers the second signal is generated by the first touch unit 30 (but actually the second signal is generated by the second touch unit 70), so that the processor 20 can process the first signal and the second signal simultaneously. One virtual first touch unit 31 may correspond to one second touch unit 70, or one virtual first touch unit 31 may correspond to a plurality of second touch units 70. The processor 20 obtains a virtual first coordinate of the virtual first touch unit 31 in the functional area 101 according to the second signal, and obtain a second coordinate of the touched second touch unit 70 in the combination area 102 according to the virtual first coordinate. The processor 20 then executes a touch control instruction (e.g., ctrl) corresponding to the second coordinate. Finally, the processor 20 obtains a combined touch control instruction (e.g., ctrl+A) according to the touch control instruction corresponding to the first coordinate and the touch control instruction corresponding to the second coordinate so as to realize the combined touch operation.

In addition, the touch device 1 of the present application further comprises a memory, wherein the touch control instructions corresponding to the coordinates in the functional area 101 and the combination area 102 are stored in the memory, and the touch control instructions after the combination of the touch control instructions are also stored in the memory. Therefore, after the processor 20 obtains the first coordinate and the second coordinate, the touch control instruction corresponding to the first coordinate and the touch control instruction corresponding to the second coordinate can be called from the memory, and the combined touch control instruction is called from the memory according to the touch control instruction corresponding to the first coordinate and the touch control instruction corresponding to the second coordinate, so that the combined touch operation is realized.

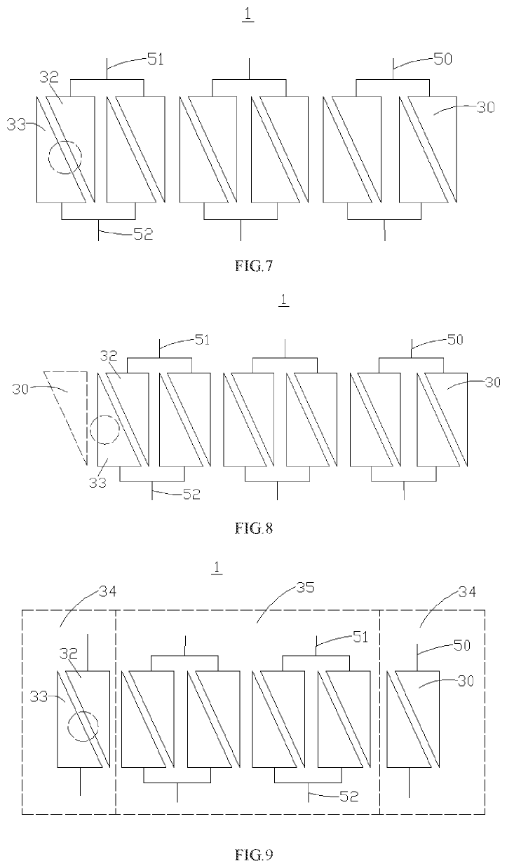

As seen in FIG. 6, FIG. 6 is a schematic diagram of a first touch unit and wiring in the touch device of the related art. One end of the wiring 50 is electrically connected with the first touch unit 30, and the other end is electrically connected with the processor 20. It will also be appreciated that the wirings 50 are configured for communicating signals generated by the first touch unit 30 to the processor 20. In addition, the first touch unit 30 includes a first driving electrode 32 and a first sensing electrode 33. In the related art, in order to reduce the number of wirings 50, save costs, and reduce the burden on the processor 20, it is common to electrically connect a plurality of first driving electrodes 32 to the same first wiring 51, and a plurality of first sensing electrodes 33 to the same second wiring 52. However, the above-described solution results in a large error between the coordinate of the touched position obtained by the processor 20 and the coordinate of the actual touched position when the first touch unit 30 located in the frame area 34 is touched . For reasons of error, reference is made to FIGS. 7 and 8. FIGS. 7 and 8 illustrate the reasons why the processor 20 cannot accurately make a judgment when the first touch unit 30 located in the frame area 34 is touched in the related art.

As shown in FIG. 7, when a user touches an area of a circular frame, since two adjacent first driving electrodes 32 are electrically connected with the same first wiring 51 and two adjacent first sensing electrodes 33 are electrically connected with the same second wiring 52, the processor 20 performs calculation in terms of average current change of the first driving electrode 32 and the first sensing electrodes 33 electrically connected with the same first wiring 51 and the second wiring 52 when performing calculation . However, the user actually touches only one first driving electrode 32 and one first sensing electrode 33, and actually only the current of the touched first driving electrode 32 and the first sensing electrode 33 changes, while the other first driving electrode 32 and the first sensing electrode 33 do not change in the current. For example, if the position touched by the user causes the first touch unit 30 to have a current change of 1 A, the processor 20 calculates that only a current change of 0.5 A has occurred. Therefore, an error occurs between the coordinate of the touched position obtained by the processor 20 and the coordinate of the actual touched position.

As shown in FIG. 8, when the touch position of the user still partially does not cover the first touch unit 30, i.e., the left half of the circular frame theoretically touches the other first touch unit 30 (which actually does not exist and is indicated by a dotted line), the error between the coordinate of the touched position obtained by the processor 20 and the coordinate of the actual touched position is further increased due to the lack of the current change contributed by the virtual touch unit.

As seen in FIG. 9, FIG. 9 is a schematic diagram of a first touch unit in a touch device according to a second embodiment of the present application. The structure of the first touch unit 30 provided by the second embodiment of the present application is substantially the same as the structure of the electrode layer 110 provided by the first embodiment of the present application, except that in the present embodiment, the first touch unit 30 comprises a first driving electrode 32 and a first sensing electrode 33, and the first driving electrode 32 and the first sensing electrode 33 are arranged at intervals in an insulating manner and are electrically connected with the processor 20 respectively; the touch device 1 further comprises a wiring 50, the wiring 50 comprises a first wiring 51 and a second wiring 52, the first wiring 51 is configured for being electrically connected with the first driving electrode 32, and the second wiring 52 is configured for being electrically connected with the first sensing electrode 33; and the functional area 101 comprises a frame area 34 and a non-frame area 35, one or more first driving electrodes 32 of the first touch unit 30 arranged in the non-frame area 35 are electrically connected with the same first wiring 51, and one or more first sensing electrodes 33 of the first touch unit 30 arranged in the non-frame area 35 are electrically connected with the same second wiring 52. One of the first driving electrodes 32 of the first touch unit 30 arranged in the frame area 34 is electrically connected with one of the first wirings 51, and one of the first sensing electrodes 33 of the first touch unit 30 arranged in the frame area 34 is electrically connected with one of the second wirings 52.

The manner in which the first touch unit 30 is arranged in the present application is not limited in the present application, and the first touch units 30 may be provided in the form of a row and a plurality of columns, a column and a plurality of rows, or a plurality of columns and a plurality of rows. This application is indicated in the form of arranging the first touch units 30 into a row and a plurality of columns. In addition, for the first driving electrode 32 and the first sensing electrode 33, the materials of the first driving electrode 32 and the first sensing electrode 33 may be Indium-Tin Oxide (ITO). The pattern of the first driving electrode 32 and the first sensing electrode 33 may form a pattern as shown in FIG. 9. The patterns of the first driving electrode 32 and the first sensing electrode 33 are congruent right triangles, and the first driving electrode 32 and the first sensing electrode 33 are symmetrically arranged in the center. In other embodiments of the present application, the patterns of the first driving electrode 32 and the first sensing electrode 33 may also take other forms. For example, alternatively, the patterns of the first driving electrode 32 and the first sensing electrode 33 may be square, rectangular, parallelogram, or other common electrode patterns. Here, it is necessary to supplement that since the patterns of the first driving electrode 32 and the first sensing electrode 33 have various possibilities, the patterns of the first touch unit 30 formed by sequentially arranging the first driving electrode 32 and the first sensing electrode 33 have various possibilities. A person skilled in the art would be able to adjust and select an appropriate pattern of the first touch unit 30 (or an appropriate pattern of the first driving electrode 32 and the first sensing electrode 33) according to practical requirements, which will not be described in detail herein.

It can be seen from the above that there is a larger error of a detection result of the processor 20 of the first touch unit 30 arranged in the frame area 34. Therefore, in the application, one of the first driving electrodes 32 of the first touch unit 30 arranged in the frame area 34 is electrically connected with one of the first wirings 51, and one of the first sensing electrodes 33 is electrically connected with one of the second wirings 52, so that when a user touches (e.g., a circular frame in FIG. 9), the processor 20 only calculates the current change of the touched first driving electrode 32 and first sensing electrode 33, instead of calculating the average change of the current of several first driving electrodes 32 and first sensing electrodes 33. Therefore, the results calculated by the processor 20 are made more accurate. Therefore, the present embodiment can alleviate the problem of the larger error of the detection result of the processor 20 of the first touch unit 30 arranged in the frame area 34.

Optionally, the resistance between the first wirings 51 is equal, and the resistance between the second wirings 52 is equal. Since both the first wiring 51 and the second wiring 52 are electrically connected with the processor 20, and signals generated by the first driving electrode 32 and the first sensing electrode 33 are transmitted to the processor 20 via the first wiring 51 and the second wiring 52, the signals are attenuated on the first wiring 51 and the second wiring 52 due to the presence of resistance. Therefore, the present application equalizes the resistance between the first wirings 51, thereby making the first signals attenuated to the same extent, and improving the calculation accuracy of the processor 20. By the same token, the present application may also equalize the resistance between the second wirings 52, so that the second signals are attenuated to the same extent, further improving the calculation accuracy of the processor 20.

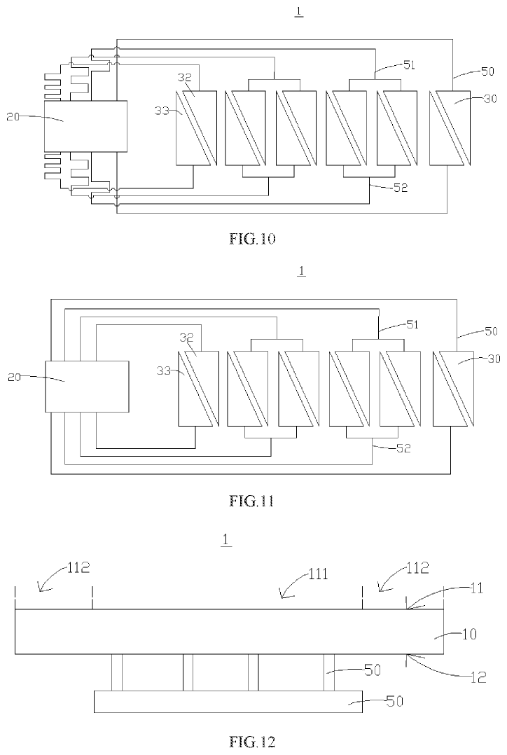

As seen in FIG. 10, FIG. 10 is a schematic structural diagram of a touch device according to a third embodiment of the present application. The structure of the touch device 1 provided by the third embodiment of the present application is substantially the same as the structure of the touch device 1 provided by the second embodiment of the present application, except that in the present embodiment, the length of the first wiring 51 and the second wiring 52 close to the processor 20 is equal to the length of the first wiring 51 and the second wiring 52 away from the processor 20. This embodiment can equalize the resistance between the first wirings 51 and the resistance between the second wirings 52 by controlling the length of the first wirings 51 and the second wirings 52. For example, the first wirings 51 close to the processor 20 are controlled to be bent several more times to increase the length, so that the length of each first wiring 51 is equal. Similarly, the second wirings 52 close to the processor 20 are controlled to be bent several more times to increase the length, so that the length of each second wiring 52 is equal.

As seen in FIG. 11, FIG. 11 is a schematic structural diagram of a touch device according to a fourth embodiment of the present application. The structure of the touch device 1 provided by the fourth embodiment of the present application is substantially the same as the structure of the touch device 1 provided by the second embodiment of the present application, except that in the present embodiment, the electrical resistivity of the first wiring 51 and the second wiring 52 close to the processor 20 is larger than the electrical resistivity of the first wiring 51 and the second wiring 52 away from the processor 20, so that the electrical resistivity between the first wirings 51 is equal, and the electrical resistivity between the second wirings 52 is equal. Another embodiment of the present application may also simplify the structure of the wiring by controlling the resistivity to equalize the resistance between the first wirings 51 and the resistance between the second wirings 52.

As seen in FIG. 12, FIG. 12 is a schematic cross-sectional view of a touch device according to a fifth embodiment of the present application. The structure of the touch device 1 provided by the fifth embodiment of the present application is substantially the same as the structure of the touch device 1 provided by the fourth embodiment of the present application, except that in the present embodiment, the touch panel 10 comprises a touch surface 11 and a non-touch surface 12 which are oppositely arranged, the touch surface 11 is configured for enabling a user to touch and provided with a touch area 111 and a non-touch area 112, and the wiring 50 is close to the non-touch surface 12 and is arranged corresponding to the touch area 111 so as to reduce the area of the non-touch area 112. It will also be understood that the wiring 50 is arranged below the touch panel 10 (as shown in FIG. 12), and that the front projection of the wiring 50 on the touch panel 10 is within the touch area 111. The area of the non-touch area 112 is reduced by arranging the wiring 50 close to the non-touch surface 12 and corresponding to the touch area 111, so that the area of the touch area 111 occupying the touch surface 11 is increased.

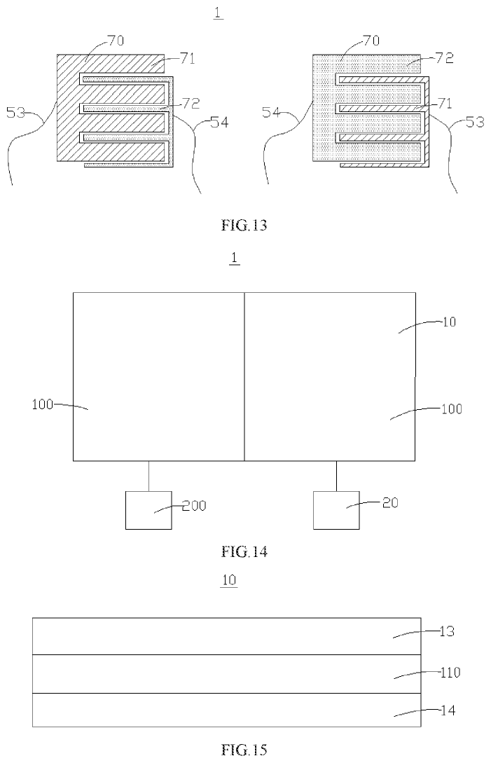

As seen in FIG. 13, FIG. 13 is a schematic structural diagram of a second touch unit in a touch device according to a sixth embodiment of the present application. The structure of the second touch unit 70 provided by the sixth embodiment of the present application is substantially the same as the structure of the second touch unit 70 of the first embodiment of the present application, except that in the present embodiment, the second touch unit 70 comprises a second driving electrode 71 and a second sensing electrode 72, the second driving electrode 71 and the second sensing electrode 72 are arranged at intervals in an insulating manner and are electrically connected to the processor 20 respectively, and the area of the second driving electrode 71 is not equal to the area of the second sensing electrode 72. For every two of the second touch units 70: a second touch unit 70 (N) and a second touch unit 70 (M), the area of the second driving electrode 71 in the second touch unit 70 (N) is equal to the area of the second sensing electrode 72 in the second touch unit 70 (M). The area of the second sensing electrode 72 in the second touch unit 70 (N) is equal to the area of the second driving electrode 71 in the second touch unit 70 (M).

The present application is not limited to the shapes of the second driving electrode 71 and the second sensing electrode 72. The second driving electrode 71 and the second sensing electrode 72 may have some standard shapes, such as a triangle, a square, a rectangle, or a parallelogram. Alternatively, the second driving electrode 71 and the second sensing electrode 72 may have a special shape, as shown in FIG. 13. It can be seen from the above contents that when the processor 20 of the present application processes and calculates the first signal and the second signal, the virtual first touch unit 31 can be established at the periphery of the first touch unit 30, and a connection relationship is established between the virtual first touch unit 31 and the second touch unit 70 so that the processor 20 can simultaneously process the first signal and the second signal transmitted by the first touch unit 30 and the second touch unit 70. In addition, a second driving electrode 71 and a second sensing electrode 72 with unequal areas are arranged, and the area of the second driving electrode 71 in the second touch unit 70 (N) is equal to the area of the second sensing electrode 72 in the second touch unit 70 (M); and the area of the second sensing electrode 72 in the second touch unit 70 (N) is equal to the area of the second driving electrode 71 in the second touch unit 70 (M). Thus, for each two of the second touch units 70 (the second touch unit 70 (N) and the second touch unit 70 (M)), since the areas of the second driving electrode 71 and the second sensing electrode 72 are opposite, the transmitted second signals are also opposite, so that each two-second touch units 70 can share one virtual first touch unit 31, thereby reducing the number of virtual first touch units 31 and then the difficulty of processing by the processor 20.

Alternatively, when one virtual first touch unit 31 changes, it means that the second touch unit 70 (N) or the second touch unit 70 (M) is touched for every two-second touch units 70. Since the areas of the second driving electrode 71 and the second sensing electrode 72 are opposite, the second signal transmitted to the processor 20 is also opposite. For example, when the second signal is a voltage voltage signal, the two voltage signals are opposite numbers to each other; and when the second signal is a current signal, the two current signals are also opposite numbers to each other. Thus, the processor 20 may determine the touched second touch unit 70 based on the positive and negative shape of its second signal. For example, when the second signal is a positive number, the processor 20 can judge that the touched second touch unit 70 is the second touch unit 70 (N); and when the second signal is negative, the processor 20 may judge that the second touch unit 70 to be touched is the second touch unit 70 (M).

Alternatively, the wiring 50 further comprises a third wiring 53 and a fourth wiring 54, the third wiring 53 is electrically connected with the second driving electrode 71, the fourth wiring 54 is electrically connected with the second sensing electrode 72, and the processor 20 is configured for detecting the second signals loaded on the third wiring 53 and the fourth wiring 54 and judges the second touch unit 70 to be touched according to the second signals.

Alternatively, for every two-second touch units 70, when the second touch unit 70 (N) or the second touch unit 70 (M) is touched, it is equivalent to the second touch unit 70 (N) or the second touch unit 70 (M) both being touched, and then the second signals of the second touch unit 70 (N) and the second touch unit 70 (M) are a fixed value, and the second signal of the second touch unit 70 (N) and the second signal of the second touch unit 70 (M) are opposite numbers to each other so that the processor 20 can more accurately judge the touched second touch unit 70, reducing the processing difficulty of the processor 20.

For example, when a current signal change of 1 A is generated on the virtual first touch unit 31, the processor 20 can know that the second touch unit 70 (N) or the second touch unit 70 (M) is touched. When the second touch unit 70 (N) is touched, it is equivalent to all the second touch units 70 (N) being touched; and at this time, the second current signal transmitted by the second touch unit 70 (N) is 1 A. When the second touch unit 70 (M) is touched, it is equivalent to all the second touch units 70 (M) being touched; and at this time, the second current signal transmitted by the second touch unit 70 (M) is −1 A. Therefore, the processor 20 can accurately know that the second touch unit 70 (N) is touched, so that the processor 20 executes the touch control instruction corresponding to the second touch unit 70 (N).

As seen in FIG. 14, FIG. 14 is a schematic structural diagram of a touch device according to a seventh embodiment of the present application. The structure of the touch device 1 provided by the sixth embodiment of the present application is substantially the same as the structure of the touch device 1 provided by the first embodiment of the present application, except that in the present embodiment, the touch panel 10 is a self-contained touch panel. The touch panel 10 comprises a plurality of sub-touch panels 100, the processor 20 comprises a plurality of sub-processors 200, and one of the sub-touch panels 100 is electrically connected with one of the sub-processors 200.

By adopting the self-contained touch panel, the problems of low touch sensitivity and even touch failure can be solved. In addition, the touch panel 10 of the present application comprises a plurality of sub-touch panels 100, and the processor 20 comprises a plurality of sub-processors 200. It will also be understood that the touch panel 10 is comprised of a plurality of sub-touch panels 100, and that one of the sub-touch panels 100 is electrically connected with one of the sub-processors 200. Because it is difficult to prepare the touch panel 10 with a large size, the touch panel 10 with a large size can be spliced into one touch panel 10 with a large size by a plurality of sub-touch panels 100 in a splicing mode. For example, when the touch device 1 is used for a touch keyboard, since the shape of the keyboard is generally rectangular, the rectangular touch panel 10 can be formed by splicing a plurality of sub-touch panels 100.

In addition, only two-point touch control is generally supported in the self-contained touch panel. If the touch panel 10 of the present application is intended to support a two-point and above touch control operation, it can be realized in an embodiment by changing the underlying algorithm of the processor 20; in the embodiment, one of the sub-touch panels 100 is electrically connected with one of the sub-processors 200, so that two-point touch control can be supported in each sub-touch panel 100. When the touch panel 10 is composed of n sub-touch panels 100 (n is not less than 2, and n is an integer), the touch panel 10 can support 2n-point touch control. The touch control effect of the touch device 1 can be further improved. In addition, by adopting the self-contained touch panel in the present application, the problem of random point reporting of the processor 20 when an ultra-thin electronic apparatus is not flattened (for example, a part of the electronic apparatus is warped) can also be prevented.

As seen in FIG. 15, FIG. 15 is a schematic structural diagram of a touch device according to an eighth embodiment of the present application. The structure of the touch device 1 provided by the eighth embodiment of the present application is substantially the same as the structure of the touch device 1 provided by the first embodiment of the present application, except that in the present embodiment, the touch panel 10 further comprises a first substrate 13 and a second substrate 14, and the electrode layer 110 is arranged between the first substrate 13 and the second substrate 14.

The present application may provide a first substrate 13 and a second substrate 14 on opposite sides of the electrode layer 110 to protect the electrode layer 110. In addition, by using a single-layer electrode layer 110 in the present application, the thickness of the touch panel 10 can be effectively reduced, thereby reducing the total thickness of the touch device 1. It can also be understood that the first driving electrode 32 and the first sensing electrode 33 in the first touch unit 30 are arranged on the same layer, and the second driving electrode 71 and the second sensing electrode 72 in the second touch unit 70 are arranged on the same layer. Alternatively, the first substrate 13 is a top substrate of the touch panel 10, and the second substrate 14 is a bottom substrate of the touch panel 10. It will also be understood that the first substrate 13 is arranged on an outermost side of the electronic apparatus 2 and in a direction towards the user, the first substrate 13 being touchable by the user. The second substrate 14 is arranged inside the electronic apparatus 2 in a direction away from the user, and the user cannot touch the second substrate 14.

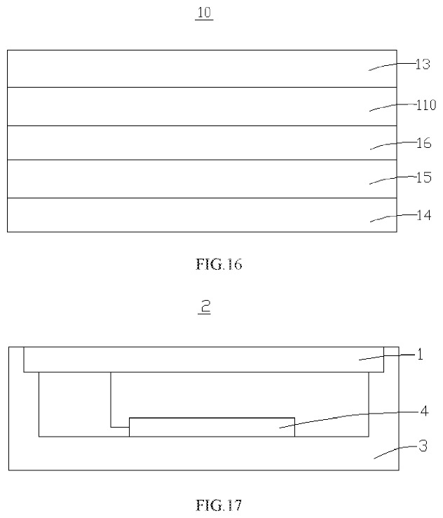

As seen in FIG. 16, FIG. 16 is a schematic structural diagram of a touch device according to a ninth embodiment of the present application. The structure of the touch device 1 provided by the ninth embodiment of the present application is substantially the same as the structure of the touch device 1 provided by the eighth embodiment of the present application, except that in the present embodiment, the touch panel 10 further comprises a shielding layer 15 arranged between the electrode layer 110 and the second substrate 14 and a connection layer 16 arranged between the electrode layer 110 and the shielding layer 15.

When the touch device 1 is placed on a conductive object, such as a metal table, the touch device 1 is susceptible to interference by an electric or magnetic field around the conductive object, which is transmitted to the touch device 1 through the conductive object, thereby reducing the judgment accuracy and precision of the processor 20. According to the invention, the shielding layer 15 is additionally arranged between the electrode layer 110 and the second substrate 14, and the shielding layer 15 can effectively shield interference of an external electric field or a magnetic field, improving the judgment accuracy and precision of the processor 20. In addition, the connection layer 16 can be arranged between the electrode layer 110 and the shielding layer 15, and the connection layer 16 can effectively fixedly connect the electrode layer 110 and the shielding layer 15. Alternatively, the connection layer 16 is an optical adhesive layer which not only fixedly connects the electrode layer 110 and the shielding layer 15 together, but also insulates the electrode layer 110 from the shielding layer 15. Alternatively, the connection layer 16 may also be arranged between the first substrate 13 and the electrodes, and the connection layer 16 may also be arranged between the shielding layer 15 and the second substrate 14.

See FIG. 17. FIG. 17 is a schematic structural diagram of an electronic apparatus according to an embodiment of the present application. In the embodiment, the electronic apparatus 2 comprises a shell 3, and a main board 4 and a touch device 1 arranged in the shell 3, wherein the main board 4 is electrically connected with the touch device 1, and the touch device 1 comprises the touch device 1 provided by any one of the first embodiment to the ninth embodiment of the present application.

The present application provides an electronic apparatus 2. The electronic apparatus 2 provided by the present application includes, but is not limited to, mobile terminals, such as a touch keyboard, a cell phone, a tablet computer, a notebook computer, a palm computer, a personal computer (PC), a personal digital assistant (PDA), a portable media player (PMP), a navigation device, a wearable device, a smart bracelet, a pedometer, and the like, and fixed terminals such as a digital TV, a desktop computer, and the like.

According to the electronic apparatus 2 provided by the application, the problem that touch control judgment is inaccurate due to the condition of ghost points during multi-point touch control or combined touch control in the related art is avoided by using the touch device 1 provided by any one of the first embodiment to the ninth embodiment of the application.

The content provided by the embodiments of the application is described in detail, the principle and the embodiments of the application are illustrated and described, and the above description is only used for helping to understand the method and the core idea of the application. Meanwhile, for a person skilled in the art, there will be changes in the specific embodiments and application scope according to the idea of the present application. In summary, the present description should not be construed as limiting the present application.

What is claimed is:

1. A touch device, comprising a touch panel and a processor, and the touch panel being electrically connected with the processor;
the touch panel provided with a functional area and a combination area,
the touch panel comprising an electrode layer, the electrode layer comprising a plurality of first touch units and a plurality of second touch units, and the first touch units and the second touch units being arranged at intervals in an insulating manner and electrically connected with the processor respectively;
the first touch unit arranged corresponding to the functional area, and the second touch unit arranged corresponding to the combination area;
when the first touch unit in the functional area and the second touch unit in the combination area are touched simultaneously, the first touch unit sending a first signal to the processor, the second touch unit sending a second signal to the processor, and the processor detecting the first signal and the second signal at a touch position, and executing corresponding functions according to the first signal and the second signal to realize a combined touch operation.

2. The touch device according to claim 1, when the first touch unit in the functional area and the second touch unit in the combination area are simultaneously touched, the processor acquiring the first signal according to the touched first touch unit to obtain a first coordinate of the touched first touch unit in the functional area according to the first signal;
the processor establishing a virtual first touch unit located at the periphery of the functional area and acquiring the second signal according to the touched second touch unit to obtain a virtual first coordinate of the virtual first touch unit in the functional area according to the second signal and obtain a second coordinate of the touched second touch unit in the combination area according to the virtual first coordinate; and
the processor executing corresponding functions according to the first coordinate and the second coordinate to realize the combined touch operation.

3. The touch device according to claim 1, wherein the first touch unit comprises a first driving electrode and a first sensing electrode, and the first driving electrode and the first sensing electrode being arranged at intervals in an insulating manner and electrically connected with the processor respectively;
the touch device further comprising a wiring, the wiring comprising a first wiring and a second wiring, the first wiring configured for being electrically connected with the first driving electrode, and the second wiring configured for electrically connected with the first sensing electrode; and the functional area comprising a frame area and a non-frame area, one or more first driving electrodes of the first touch unit arranged in the non-frame area being electrically connected with the same first wiring, and one or more first sensing electrodes of the first touch unit arranged in the non-frame area being electrically connected with the same second wiring.

4. The touch device according to claim 3, wherein one of the first driving electrodes of the first touch unit arranged in the frame area is electrically connected with one of the first wirings, and one of the first sensing electrodes of the first touch unit arranged in the frame area is electrically connected with one of the second wirings.

5. The touch device according to claim 3, wherein the resistance between the first wirings is equal, and the resistance between the second wirings is equal.

6. The touch device according to claim 5, wherein the length of the first wiring and the second wiring close to the processor is equal to the length of the first wiring and the second wiring away from the processor.

7. The touch device according to claim 5, wherein the touch panel comprises a touch surface and a non-touch surface which are oppositely arranged, the touch surface configured for enabling a user to touch and provided with a touch area and a non-touch area, and the wiring being close to the non-touch surface and arranged corresponding to the touch area so as to reduce the area of the non-touch area.

8. The touch device according to claim 1, wherein the second touch unit comprises a second driving electrode and a second sensing electrode, the second driving electrode and the second sensing electrode being arranged at intervals in an insulating manner and electrically connected with the processor respectively, and the area of the second driving electrode being not equal to the area of the second sensing electrode.

9. The touch device according to claim 8, wherein for every two of the second touch units: a second touch unit (N) and a second touch unit (M), the area of the second driving electrode in the second touch unit (N) being equal to the area of the second sensing electrode in the second touch unit (M); and the area of the second sensing electrode in the second touch unit (N) being equal to the area of the second driving electrode in the second touch unit (M).

10. The touch device according to claim 9, wherein the wiring further comprises a third wiring and a fourth wiring, the third wiring electrically connected with the second driving electrode, the fourth wiring electrically connected with the second sensing electrode, and the processor configured for detecting the second signal loaded on the third wiring and the fourth wiring, and judging the touched second touch unit according to the second signal.

11. The touch device according to claim 1, wherein the touch panel is a self-contained touch panel.

12. The touch device according to claim 1, wherein the touch panel comprises a plurality of sub-touch panels, the processor comprises a plurality of sub-processors, and one of the sub-touch panels is electrically connected with one of the sub-processors.

13. The touch device according to claim 1, wherein the touch panel further comprises a first substrate and a second substrate, and the electrode layer is arranged between the first substrate and the second substrate.

14. The touch device according to claim 13, wherein the touch panel further comprises a shielding layer arranged between the electrode layer and the second substrate, and a connection layer is arranged between the electrode layer and the shielding layer.

15. An electronic apparatus, comprising a shell, and a main board and a touch device arranged in the shell, wherein the main board is electrically connected with the touch device, and the touch device comprises the touch device; wherein the touch device comprises a touch panel and a processor, and the touch panel being electrically connected with the processor;
the touch panel provided with a functional area and a combination area,
the touch panel comprising an electrode layer, the electrode layer comprising a plurality of first touch units and a plurality of second touch units, and the first touch units and the second touch units being arranged at intervals in an insulating manner and electrically connected with the processor respectively;
the first touch unit arranged corresponding to the functional area, and the second touch unit arranged corresponding to the combination area;
when the first touch unit in the functional area and the second touch unit in the combination area being touched simultaneously, the first touch unit sending a first signal to the processor, the second touch unit sending a second signal to the processor, and the processor detecting the first signal and the second signal at a touch position, and executing corresponding functions according to the first signal and the second signal to realize a combined touch operation.

16. The electronic apparatus according to claim 15, when the first touch unit in the functional area and the second touch unit in the combination area being simultaneously touched, the processor acquiring the first signal according to the touched first touch unit to obtain a first coordinate of the touched first touch unit in the functional area according to the first signal;
the processor also establishing a virtual first touch unit located at the periphery of the functional area and acquiring the second signal according to the touched second touch unit to obtain a virtual first coordinate of the virtual first touch unit in the functional area according to the second signal and obtain a second coordinate of the touched second touch unit in the combination area according to the virtual first coordinate; and the processor executing corresponding functions according to the first coordinate and the second coordinate to realize the combined touch operation.

17. The electronic apparatus according to claim 15, wherein the first touch unit comprises a first driving electrode and a first sensing electrode, and the first driving electrode and the first sensing electrode being arranged at intervals in an insulating manner and electrically connected with the processor respectively;
the touch device further comprising a wiring which comprises a first wiring and a second wiring, the first wiring configured for being electrically connected with the first driving electrode, and the second wiring configured for being electrically connected with the first sensing electrode; and the functional area comprising a frame area and a non-frame area, one or more first driving electrodes of the first touch unit arranged in the non-frame area being electrically connected with the same first wiring, and one or more first sensing electrodes of the first touch unit arranged in the non-frame area being electrically connected with the same second wiring.

18. The electronic apparatus according to claim 16, wherein the resistance between the first wirings is equal, the resistance between the second wirings is equal, the length of the first wiring and the second wiring close to the processor is equal to the length of the first wiring and the second wiring away from the processor.

19. The electronic apparatus according to claim 15, wherein the second touch unit comprises a second driving electrode and a second sensing electrode, the second driving electrode and the second sensing electrode being arranged at intervals in an insulating manner and electrically connected with the processor respectively, and the area of the second driving electrode being not equal to the area of the second sensing electrode.

20. The electronic apparatus according to claim 15, wherein the touch panel comprises a plurality of sub-touch panels, the processor comprises a plurality of sub-processors, and one of the sub-touch panels is electrically connected with one of the sub-processors;
the touch panel comprising a first substrate and a second substrate, and the electrode layer is arranged between the first substrate and the second substrate;
the touch panel comprising a shielding layer arranged between the electrode layer and the second substrate, and a connection layer is arranged between the electrode layer and the shielding layer.
